(19) United States
(12) Patent Application Publication
(10) Pub. No.: US 2017/0186055 A1
(43) Pub. Date: Jun. 29, 2017

(54) IMPROVED REVIEWS AND RATINGS

(71) Applicant: EINSTEIN INDUSTRIES, INC., San Diego, CA (US)

(72) Inventors: Robert SILKEY, San Diego, CA (US); Ted RICASA, San Diego, CA (US); Sergiy ZUBATIY, San Diego, CA (US); Michael HAWKINS, San Diego, CA (US); Michael HURLEY, San Diego, CA (US); Christopher CHERRY, San Diego, CA (US)

(21) Appl. No.: 15/129,754

(22) PCT Filed: Mar. 26, 2015
(86) PCT No.: PCT/US2015/022845

§ 371 Date: Sep. 27, 2016

Related U.S. Application Data
(60) Provisional application No. 61/971,077, filed on Mar. 27, 2014.

(51) Int. Cl. G06Q 30/02

(52) U.S. Cl. CPC G06Q 30/0282

(57) ABSTRACT

Screening feedback and/or generating aggregate feedback for an entity. In an embodiment, feedback is received from users. For each feedback, it is determined whether the feedback is negative or positive. When the feedback is negative, a first user interface is provided, comprising input(s) for receiving information about the negative feedback, without publishing the negative feedback. When the feedback is positive, a second user interface is provided, comprising input(s) to facilitate publication of the positive feedback on a plurality of external websites. In addition, aggregate feedback may be generated for an entity group that comprises at least first and second entities, based, at least in part, on published feedback for the first and second entities.

### BACKGROUND

Field of the Invention

The embodiments described herein are generally directed to feedback, and, more particularly, to feedback screening and aggregated rating processes.

Description of the Related Art

Section 230 of the Communications Decency Act of 1996 has been interpreted to state that operators of Internet services are not to be construed as publishers. As a result, these operators cannot be held legally liable for statements made by third parties who use their services. Consequently, negative reviews can be published that are untrue or unfounded with little to no repercussions.

While negative reviews can be published in a matter of seconds, they can be nearly impossible to remove. This may be true even if the person that created the negative review has since changed his or her mind or opinion and/or wishes to remove the review. Moreover, even if a negative review does manage to be removed, the detrimental effect caused by the review to a reviewee's business or reputation may be irreversible.

Some sites offer the ability to submit a rebuttal to a review. A reviewee can also seek legal action to remove certain reviews (e.g., a legal action for defamation). A Search Engine Optimization (SEO) company may also help a reviewee by flooding the Internet with propaganda designed to bury negative reviews at the bottom of search results. In addition, a reviewee can sometimes pay a fee to the operator of a site on which the negative review was posted in order to minimize or remove the negative review. However, all of these solutions are remedial measures that simply mitigate the damage caused by a published review. It would be advantageous to have a way to intercept negative, potentially inaccurate or invalid, reviews prior to their publication.

In addition, it is typically difficult for reviewers (e.g., consumers) to post positive reviews of an entity (e.g., business) in more than one place (e.g., on more than one social networking site or other website that offers reviews). There is currently no easy way for a consumer to learn about how to post positive online reviews or ratings in multiple places about a single entity. For instance, there is currently no efficient method for businesses or professionals to educate happy consumers about how to post a positive review or rating in multiple places. Thus, it would also be advantageous to have a way to educate positive reviewers on how to promote an entity by posting positive reviews on multiple sites.

Furthermore, there is currently no adequate way to provide feedback on an entity that comprises multiple, distinct sub-entities, such as a film comprising multiple professionals and/or locations, based on feedback for the sub-entities. For example, a law firm is an entity that comprises multiple lawyers and may comprise multiple locations, an accounting firm is an entity that comprises multiple accountants and may comprise multiple locations, and a medical practice may comprise multiple physicians and/or locations. Conventional rating systems only provide linear ratings capabilities (i.e., a rating for the entity or a rating for the individual sub-entities). It would be advantageous if the multiple, distinct sub-entities could be rated or reviewed, and an aggregate rating or review for the overarching entity could be generated from the ratings/reviews of its constituent sub-entities. It would also be advantageous if new customized, overarching entities could be constructed using combinations of selectable or specifiable sub-entities (e.g., an arbitrary set of sub-entities selected or specified by a user) for the purposes of an aggregate review of the sub-entities.

### SUMMARY

Accordingly, systems and methods are disclosed to improve the review and/or rating process. In embodiments, the systems and methods may utilize a feedback capture mechanism for capturing feedback (e.g., ratings and/or reviews), a routing mechanism for routing a reviewer to a negative-capture and/or positive-capture destination based on the content of the feedback, a dissuasive mechanism for dissuading a reviewer from publishing negative feedback, and/or an education mechanism which promotes positive reviews and social signals on multiple online platforms. In this manner, systems and methods bring together personalized education and social promotion to improve positive and social signals.

Furthermore, in embodiments, the systems and methods may establish entities for which feedback is sought, provide a feedback capture mechanism for capturing feedback (e.g., ratings and/or reviews) for individual sub-entities (e.g., professionals and/or locations) having a relationship to or association with one or more of the entities, a feedback-aggregation mechanism (e.g., formula or algorithm) for aggregating the feedback for the individual sub-entities into combined feedback (e.g., a combined rating and/or grouping(s) of reviews) for the associated entity or entities (e.g., representing the overall quality or characteristics of the entity or entities), and a display mechanism (e.g., user interface) for displaying the combined feedback. It should be understood that the entities may be user-specified (e.g., all sub-entities in a certain ZIP code or city, such as all lawyers in San Diego, all doctors in California, all professionals in the 92101 ZIP code).

In an embodiment, a system for screening feedback for an entity is disclosed. The system comprises: at least one hardware processor; and one or more software modules that, when executed by the at least one hardware processor, receive feedback for the entity from a user, determines whether the feedback is negative or positive, when the feedback is negative, provides a first user interface, to the user, comprising one or more inputs for receiving information about the negative feedback from the user, without publishing the negative feedback, and, when the feedback is positive, provides a second user interface, to the user, comprising one or more inputs to facilitate publication of the positive feedback on a plurality of external websites. In addition, the one or more software modules may, when the feedback is negative, communicate the negative feedback to the entity and/or initiate an offline or online dispute resolution process (e.g., via the first user interface or other user interfaces or modules). In addition, each of the one or more inputs of the second user interface, when selected, may direct the user to a corresponding one of the plurality of external websites. Alternatively or additionally, each of the one or more inputs of the second user interface, when selected, may submit the positive feedback to a corresponding one of the plurality of external websites for publication on the external website.

In an additional embodiment, a method for screening feedback for an entity is disclosed. The method comprises using at least one hardware processor to: receive feedback for the entity from a user; determines whether the feedback is negative or positive; when the feedback is negative, provides a first user interface, to the user, comprising one or more inputs for receiving information about the negative feedback from the user, without publishing the negative feedback; and, when the feedback is positive, provides a second user interface, to the user, comprising one or more inputs to facilitate publication of the positive feedback on a plurality of external websites.

In an additional embodiment, a non-transitory computer-readable medium having one or more sequences of instructions stored therein is disclosed. The one or more sequences of instructions, when executed by a processor, cause the processor to: receive feedback for the entity from a user; determines whether the feedback is negative or positive; when the feedback is negative, provides a first user interface, to the user, comprising one or more inputs for receiving information about the negative feedback from the user, without publishing the negative feedback; and, when the feedback is positive, provides a second user interface, to the user, comprising one or more inputs to facilitate publication of the positive feedback on a plurality of external websites.

In an embodiment, a system for generating aggregate feedback for an entity composed of a plurality of sub-entities is disclosed. The system comprises: at least one hardware processor; and one or more software modules that, when executed by the at least one hardware processor, receive feedback for a first one of the plurality of sub-entities from a first user, receive feedback for a second one of the plurality of sub-entities from a second user, and generate an aggregate feedback representing feedback for the entity based, at least in part, on the feedback for the first sub-entity and the feedback for the second sub-entity. In addition, the one or more software modules may display the aggregate feedback to a third user. In addition, the one or more software modules may further receive one or more criteria defining a third sub-entity from a third user. Furthermore, the one or more software modules may generate an aggregate feedback representing feedback for the third sub-entity based, at least in part, on the feedback for the first sub-entity and the feedback for the second sub-entity. One or both of the first sub-entity and the second sub-entity may represent a person or location associated with the entity.

In an additional embodiment, a method for generating aggregate feedback for an entity composed of a plurality of sub-entities is disclosed. The method comprises using at least one hardware processor to: receive feedback for a first one of the plurality of sub-entities from a first user, receive feedback for a second one of the plurality of sub-entities from a second user, and generate an aggregate feedback representing feedback for the entity based, at least in part, on the feedback for the first sub-entity and the feedback for the second sub-entity.

In an additional embodiment, a non-transitory computer-readable medium having one or more sequences of instructions stored therein is disclosed. The one or more sequences of instructions, when executed by a processor, cause the processor to: receive feedback for a first one of the plurality of sub-entities from a first user, receive feedback for a second one of the plurality of sub-entities from a second user, and generate an aggregate feedback representing feedback for the entity based, at least in part, on the feedback for the first sub-entity and the feedback for the second sub-entity.

In an additional embodiment, a system for managing feedback for an entity including a plurality of sub-entities is disclosed. The system comprises: at least one hardware processor; and one or more software modules that, when executed by the at least one hardware processor, receive first feedback for a first sub-entity from a first user, receive second feedback for a second sub-entity from a second user, determine for each of said first and second feedback, whether the feedback is negative or positive, and, when the feedback is negative, provide a first user interface, to the user, comprising one or more inputs for receiving information about the negative feedback from the user, without publishing the negative feedback, and, when the feedback is positive, provide a second user interface, to the user, comprising one or more inputs to facilitate publication of the positive feedback on a plurality of external websites, generate an aggregate feedback representing feedback for the entity based, at least in part, on the externally published feedback for the first sub-entity and the externally published feedback for the second sub-entity. In addition, the one or more software modules may receive one or more criteria defining a third sub-entity from a third user. Furthermore, the one or more software modules may generate an aggregate feedback representing feedback for the third sub-entity based, at least in part, on the externally published feedback for the first sub-entity and the externally published feedback for the second sub-entity. One or both of the first sub-entity and the second sub-entity may represent a person or location associated with the entity.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates a networked environment in which embodiments of the system, methods, or media disclosed herein operate, according to an embodiment;

FIG. 2 illustrates a feedback-submission process, according to an embodiment;

FIG. 3 illustrates a feedback-submission process, according to an embodiment;

FIG. 4 illustrates a process for generating aggregate feedback, according to an embodiment;

FIG. 5 illustrates an example of generating aggregate feedback, according to an embodiment;

FIG. 6 illustrates a processing system on which one or more of the processes described herein may be executed, according to an embodiment;

FIG. 7 illustrates a feedback submission process, according to an embodiment;

FIG. 8 illustrates screening and/or aggregating feedback on entity groups, according to an embodiment; and

FIG. 9 illustrates examples of associating feedback from users with multiple entities, according to an embodiment.

### DETAILED DESCRIPTION

In an embodiment, systems and methods are disclosed for improving the review and/or rating process for entities such as businesses and professionals. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

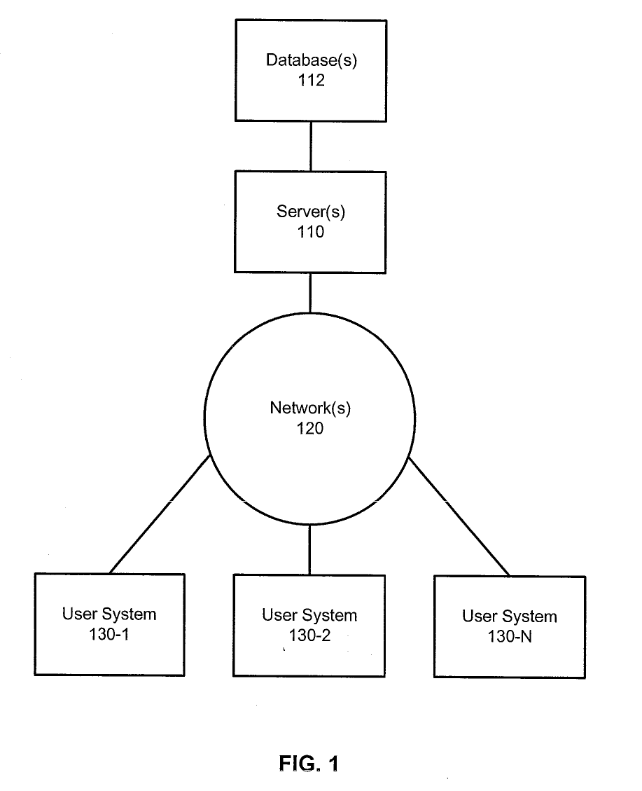

FIG. 1 illustrates an example system that forms the environment for one or more of the disclosed processes, according to an embodiment. The system may comprise a set of one or more servers 110 (also referred to herein as a “platform”) which host and/or execute one or more of the various functions, processes, methods, and/or software modules described herein. In addition, server(s) 110 may be communicatively connected to one or more user systems 130 (e.g., 130-1, 130-2, to 130-N) via one or more network(s) 120 and may also be communicatively connected to one or more database(s) 112 (e.g., via one or more network(s), such as network(s) 120) and/or may comprise one or more database(s) 112. Server(s) 110 may also be communicatively connected to one or more external systems or platforms (e.g., social networking sites, such as Facebook®, Google+®, etc., feedback sites, such as Yelp®, etc., and the like). Network(s) 120 may comprise the Internet, and server(s) 110 may communicate with user system(s) 130 through the Internet using standard transmission protocols, such as HyperText Transfer Protocol (HTTP), Secure HTTP (HTTPS), File Transfer Protocol (FTP), FTP Secure (FTPS), SSH FTP (SFTP), and the like, as well as proprietary protocols. In an embodiment, server(s) 110 may not be dedicated servers, and may instead be cloud instances, which utilize shared resources of one or more servers. It should also be understood that server(s) 110 may be, but are not required to be, collocated. Furthermore, while server(s) 110 are illustrated as being connected to various systems through a single set of network(s) 120, it should be understood that server(s) 110 may be connected to the various systems via different sets of one or more networks. For example, server(s) 110 may be connected to a subset of user systems 130 via the Internet, but may be connected to one or more other user systems 130 via an intranet. It should also be understood that user system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, and the like. In addition, while only a few user systems 130, one set of server(s) 110, and one set of database(s) 112 are illustrated, it should be understood that the network may comprise any number of user systems, sets of server(s), and database(s).

Platform 110 may comprise web servers which host one or more websites or web services. In embodiments in which a website is provided, the website may comprise one or more user interfaces, including, for example, webpages generated in HyperText Markup Language (HTML) or other language. Platform 110 transmits or serves these user interfaces in response to requests from user system(s) 130. In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to platform 110 and the responses from platform 110, including the user interfaces, may both be communicated through network(s) 120, which may include the Internet, using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (not shown) that are locally and/or remotely accessible to platform 110. Platform 110 may also respond to other requests from user system(s) 130.

Platform 110 may further comprise, be communicatively coupled with, or otherwise have access to one or more database(s) 112. For example, platform 110 may comprise one or more database servers which manage one or more databases 112. A user system 130 or application executing on platform 110 may submit data (e.g., user data, form data, etc.) to be stored in the database(s) 112, and/or request access to data stored in such database(s) 112. Any suitable database may be utilized, including without limitation MySQL™, Oracle™, IBM™, Microsoft SQL™, Sybase™, Access™, and the like, including cloud-based database instances and proprietary databases. Data may be sent to platform 110, for instance, using the well-known POST request supported by HTTP, via FTP, etc. This data, as well as other requests, may be handled, for example, by server-side web technology, such as a servlet or other software module, executed by platform 110.

In embodiments in which a web service is provided, platform 110 may receive requests from user system(s) 130, and provide responses in eXtensible Markup Language (XML) and/or any other suitable or desired format. In such embodiments, platform 110 may provide an application programming interface (API) which defines the manner in which user system(s) 130 may interact with the web service. Thus, user system(s) 130, which may themselves be servers, can define their own user interfaces, and rely on the web service to implement or otherwise provide the backend processes, methods, functionality, storage, etc., described herein. For example, in such an embodiment, a client application executing on one or more user system(s) 130 may interact with a server application executing on platform 110 to execute one or more or a portion of one or more of the various functions, processes, methods, and/or software modules described herein. The client application may be “thin,” in which case processing is primarily carried out server-side by platform 110. A basic example of a thin client application is a browser application, which simply requests, receives, and renders web pages at user system(s) 130, while platform 110 is responsible for generating the web pages and managing database functions. Alternatively, the client application may be “thick,” in which case processing is primarily carried out client-side by user system(s) 130. It should be understood that the client application may perform an amount of processing, relative to platform 110, at any point along this spectrum between “thin” and “thick,” depending on the design goals of the particular implementation. In any case, the application, which may wholly reside on either platform 110 or user system(s) 130 or be distributed between platform 110 and user system(s) 130, can comprise one or more executable software modules that implement one or more of the processes, methods, or functions of the application(s) described herein.

2. Process Overview

Embodiments of process(es) for improved feedback will now be described in detail. It should be understood that the described process(es) may be embodied in one or more software modules that are executed by one or more hardware processors, e.g., as the software application discussed above, which may be executed wholly by processor(s) of platform 110, wholly by processor(s) of user system(s) 130, or may be distributed across platform 110 and user system(s) 130 such that some portions or modules of the application are executed by platform 110 and other portions or modules of the application are executed by user system(s) 130. The described process may be implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

2.1. Feedback Submission Process

In an embodiment, an online feedback submission process comprises promoting positive feedback and/or suppressing negative feedback. This process may be implemented in software as a feedback-submission module comprising one or more software modules. This feedback-submission module may be integrated into any website or other online application, regardless of whether that application is a dedicated feedback site, an ecommerce site with a feedback option, an online directory (e.g., a directory of profiles for a plurality of professionals) search engine with a feedback option, or any other application in which it makes sense for users (e.g., consumers) to provide feedback.

The feedback submission process may begin with a user interface with one or more inputs for receiving feedback, comprising a rating and/or review, from a potential reviewer. In an embodiment, the user interface may imply to the potential reviewer that all feedback will be captured and posted or published online. Once feedback has been received from the reviewer, the feedback-submission module may determine where (e.g., to which user interface) to direct the reviewer based on the content of the feedback (e.g., whether the content is negative or positive).

For instance, if the feedback comprises a rating or ratings, the feedback-submission module may compare the rating(s) to a threshold. If the feedback comprises multiple ratings (e.g., for multiple aspects of a consumer's experience), the multiple ratings may be combined into a single rating that is compared to a single threshold or may each be individually compared to a separate threshold. In either case, if the rating is on one side of the threshold, the module may determine that the feedback is negative. Otherwise, if the rating is on the other side of the threshold, the module may determine that the feedback is positive. If the rating is equal to the threshold, the module may determine that the feedback is either negative or positive, depending on the implementation, or may determine that the feedback is neutral. It should be understood that the threshold may actually comprise two or more thresholds (e.g., so as to define one or more ranges, for example, to classify feedback into categories of negative, neutral, and/or positive). Alternatively or additionally, if the feedback comprises a review (e.g., comprising free-form text), the feedback-submission module may search the review for one or more keywords and/or apply a determinative model to the review to classify the review as either positive or negative.

In an embodiment, if the feedback is determined to be negative, the feedback- submission module directs the user to a negative-capture user interface for handling potentially negative feedback. This user interface may prompt the reviewer for additional information and comprise one or more inputs via which the reviewer may specify the additional information. This user interface may allow the reviewer to vent. For example, the user interface may comprise a questionnaire that asks the reviewer about his or her experience and one or more inputs for entering comments and submitting the questionnaire response(s). These questionnaire response(s) can then be forwarded to the reviewed entity, prior to the negative feedback being published or in lieu of publication (i.e., the negative feedback may never be published). This allows the reviewed entity to attempt to improve the relationship with the reviewer prior to or in lieu of publication and/or to evaluate the reviewed entity's systems and processes for improvement. Alternatively or additionally, the negative-capture user interface may provide information or a link to information intended to prevent or dissuade the reviewer from publishing the negative feedback. For example, dissuasive information may comprise media (e.g., text, image(s), video, etc.) that explain common misunderstandings in the consumer context. Advantageously, by allowing the reviewer to vent and/or providing a questionnaire for the user to complete, the reviewer may be forced to consider his or her negative feedback in a rational manner prior to submission, thereby avoiding reducing the instances of rash negative feedback.

In an embodiment, if the feedback is determined to be positive, the feedback-submission module directs the reviewer to a positive-capture user interface for handling potentially positive feedback. This user interface may comprise an external review platform (e.g., a website for online reviews). Alternatively, the positive-capture user interface may prompt the reviewer to submit the positive feedback to one or more other external platforms (e.g., social networking websites or applications). For example, the user interface may comprise one or more inputs which direct the reviewer to these external platforms, including user interfaces for submitting feedback to websites hosted by these external platforms. In such an embodiment, the positive-capture user interface may comprise text which may be copied to a clipboard of the reviewer for pasting into a user interface of the other sites (e.g., using the well-known copy-and-paste operation). For instance, a reviewer may copy the text (e.g., using the copy shortcut “Ctrl-C” or an input which automatically copies the text to the reviewer's clipboard), select a hyperlink to a user interface of an external website which accepts reviews, and paste the text into an input of the user interface of the external website (e.g., using the paste shortcut “Ctrl-V”). It should be understood that this copy-and-paste technique may be performed for a plurality of external websites. For example, the reviewer could return to the positive-capture user interface (e.g., using a back command of their web browser), select a second hyperlink to a user interface of a second external website which accepts reviews, and paste the text into an input of that user interface, and so forth.

Alternatively or additionally, the positive-capture user interface may comprise inputs via which the reviewer may select one or more external platforms and submit the feedback to the selected external platforms (e.g., via an API that posts the feedback to an account of the reviewer and/or profile of the reviewed entity on the external platform). In this case, the present platform may store authentication credentials for the reviewer (e.g., user identifier and password) to one or more external platforms. Alternatively or in the event that no authentication credentials for a selected external platform are stored, the present platform may prompt the reviewer to enter his or her authentication credentials or direct the reviewer to a user interface of the external platform which prompts the reviewer to enter his or her authentication credentials.

Alternatively or additionally, the positive-capture user interface may provide information or a link to information intended to encourage or persuade the reviewer to publish the positive feedback on one or more external platforms. For example, persuasive information may comprise media (e.g., text, image(s), video, etc.) that educates the reviewer on the benefits of positive feedback (e.g., how to post positive feedback on one or more social networking sites and/or how posting positive feedback on one or more social networking sites helps the entity being reviewed). In an embodiment, the persuasive information may be specifically tailored to the entity being reviewed (e.g., the needs of the entity being reviewed).

In an embodiment, the feedback-submission module may also automatically send follow-up communication(s) or a series of communications (e.g., via email message, Short Message Service (SMS) message, Multimedia Messaging Service (MMS) message, or some other communication means) to a reviewer for the purposes of promoting and/or suppressing certain types of feedback.

In an embodiment, the platform allows a reviewable entity, such as a business or professional, to specify if and/or how feedback should be published online. Thus, the entity can customize the approach. For instance, the platform may comprise one or more user interfaces which allow the reviewable entity to specify whether the feedback should be published automatically or after a manual review by the entity or an agent of the entity. The entity may be permitted to specify a different process depending on the content of the review (e.g., as determined by the feedback-submission module). For example, an entity may specify that positive feedback should be published automatically, but that negative feedback should be held for manual review. In addition, the platform may comprise one or more user interfaces which allow the reviewable entity to arrange the order of the social education for reviewers (e.g., the persuasive information used to persuade the reviewer to submit feedback on one or more external sites, such as social networking sites).

Advantageously, the disclosed feedback-submission module may improve the business of a reviewed entity. Specifically, suppressing negative feedback (e.g., ratings and/or reviews) may prevent harm to the business of a reviewed entity. Conversely, promoting positive feedback across multiple sites or applications potentially improves the business of the reviewed entity. As discussed above, a single tool can be used to capture feedback (e.g., ratings and/or reviews) and promote an entity on multiple social and/or review websites.

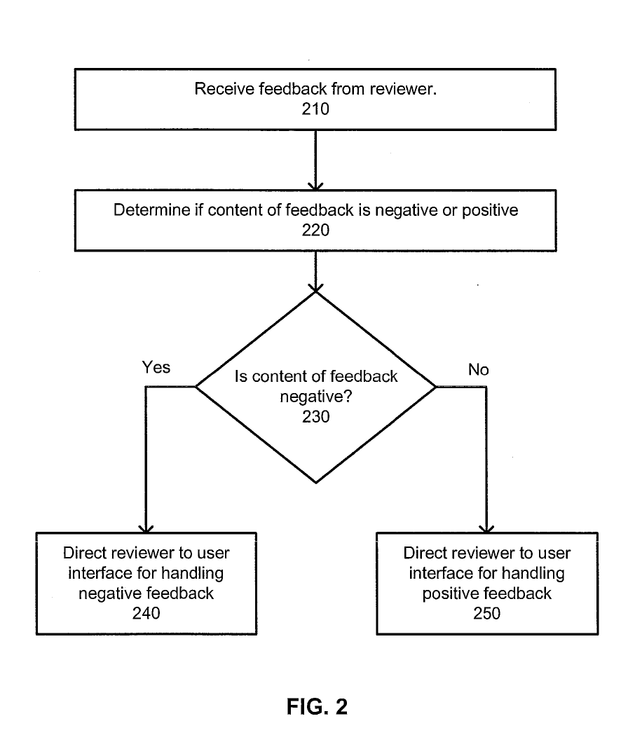

FIG. 2 illustrates the online feedback submission process 200 of the feedback-submission module, according to an embodiment. Process 200 begins in step 210, when a reviewer submits feedback, which is received by the feedback-submission module of the platform. In step 220, the feedback-submission module determines if the content is negative or positive. Then, in step 230, if the content is determined to be negative, the reviewer is directed to a user interface for handling negative feedback in step 240, Otherwise, the reviewer is directed to a user interface for handling positive feedback in step 250.

Modifications to process 200 are contemplated for alternative embodiments. For example, step 250 may be excluded. In such an embodiment, step 220 may only involve determining if the content is negative. Then, in step 230, if the content is negative, process 200 may proceed to step 240, but, otherwise, end or perform other processing.

Conversely, step 240 may be excluded. In this case, step 220 may only involve determining if the content is positive. Then, in step 230, if the content is positive, process 200 may proceed to step 250, but, otherwise, end or perform other processing.

As an additional embodiment, process 200 may distinguish negative and/or positive feedback from neutral feedback (e.g., feedback which feedback-submission module does not or cannot classify as either negative or positive). In such an embodiment, step 230 may comprise two steps: (1) if the content is negative, proceeding to step 240; and (2) if the content is positive, proceeding to step 250. If the content is neither negative nor positive, process 200 may end, direct the reviewer to a user interface for handling neutral feedback, or perform other processing (e.g., publishing the feedback).

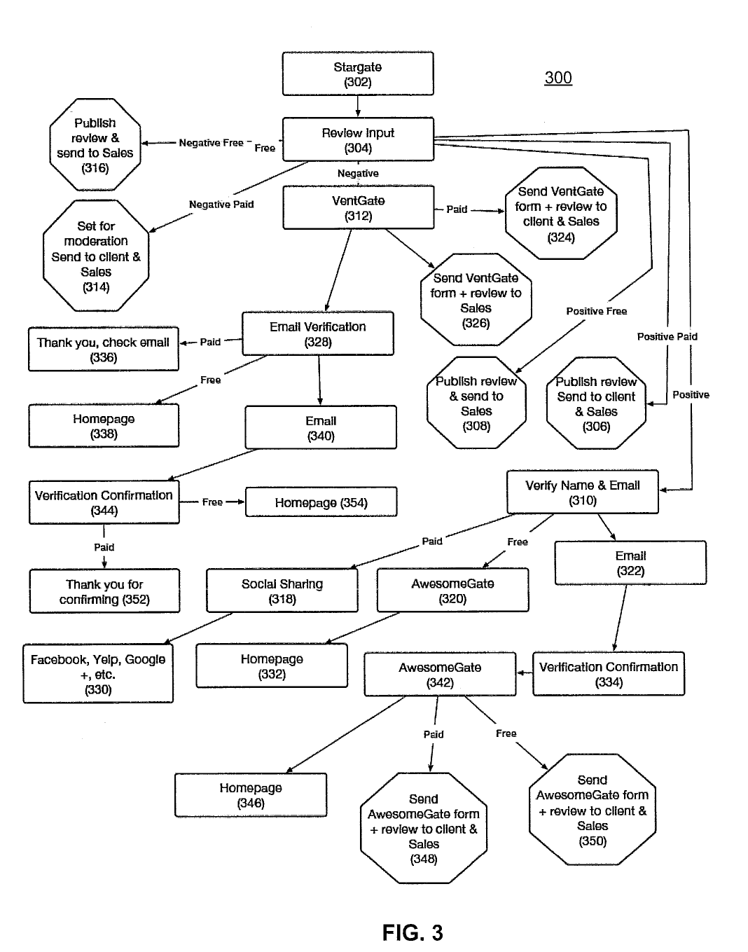

FIG. 3 is a flow diagram for an online feedback submission process 300 of the feedback-submission module, according to a more detailed embodiment. In process 300, certain optional branching is based on whether an account or subscription of a reviewable entity with the platform is paid or free. However, it should be understood that, in alternative embodiments of process 300, which utilize either only paid or only free accounts, only the branches labeled “paid” may be present or only the branches labeled “free” maybe present, respectively.

Process 300 begins in step 302 in which feedback (e.g., comprising a rating and/or review) from a reviewer is received for a reviewed entity. In step 304, it is determined whether the received feedback is positive or negative. If the feedback is positive, process 300 may proceed to step 310 in which a positive-feedback-handling sub-process may be initiated. This positive-feedback-handling process may comprise the initiation of a verification process, e.g., by collecting a name and email address and/or other identifying information from the reviewer. Otherwise, if the feedback is negative, process 300 proceeds to step 312 in which a negative-feedback-handling sub-process may be initiated. This negative-feedback-handling sub-process may comprise providing facilities (e.g., user interfaces and/or process modules) to the reviewer and/or reviewed entity for improving the relationship between the two, and may comprise not publishing the negative feedback or delaying publication of the negative feedback until the reviewer and reviewed entity have had an opportunity to resolve any issues. For example, step 312 may comprise presenting user interface(s) to the reviewer which may comprise a questionnaire that asks the reviewer about his or her experience and comprises an input for entering comments and submitting the questionnaire response(s). These questionnaire response(s) can then be forwarded to the reviewed entity, prior to the negative feedback being published or in lieu of publication. This allows the reviewed entity to attempt to improve the relationship with the reviewer prior to or in lieu of publication and/or to evaluate the reviewed entity's systems and processes for improvement.

In an embodiment with paid and free accounts, if it is determined in step 304 that the feedback is positive and the reviewed entity has a paid account, process 300 proceeds to step 306 in which the feedback is published and may be sent to the reviewed entity and/or a sales department or other department or recipient (e.g., the operator of the platform executing the feedback-submission module). On the other hand, if the feedback is positive and the reviewed entity does not have a paid account, process 300 proceeds to step 308 in which the feedback is published and may be sent to the reviewed entity, sales department of the entity and/or operator, and/or other recipient. In addition, if it is determined in step 304 that the feedback is negative and the reviewed entity has a paid account, process 300 proceeds to step 314 in which the feedback is set for moderation or mediation (e.g., between the reviewer and reviewed entity) and may be sent to the reviewed entity, sales depaitment of the entity and/or operator, and/or other recipient. On the other hand, if the feedback is negative and the reviewed entity does not have a paid account, process 300 proceeds to step 316 in which the feedback is published and may be sent to the reviewed entity, sales department of the entity and/or operator, and/or other recipient.

Returning to step 310, the verification process of the positive-feedback-handling sub-process may comprise sending an email message to the email address of the reviewer (e.g., obtained in step 310) in step 322. The email message may comprise a link (e.g., comprising a Uniform Resource Locator (URL)) and/or code (e.g., character string) to confirm that the email address is valid and accessible by the reviewer. In step 334, if the reviewer follows the link and/or enters the code into a confirmation user interface of the platform, the reviewer is directed to a user interface for publishing the feedback in step 342.

In an alternative embodiment with paid and free accounts, if the reviewed entity has a paid account, process 300 proceeds from step 310 to step 318, in which the reviewer is encouraged to submit the feedback to one or more external social networking and/or review sites in step(s) 330 (e.g., Facebook®, Yelp®, Google+®, etc.). On the other hand, if the reviewed entity does not have a paid account, the reviewer is directed to a user interface for publishing or otherwise capturing the feedback (e.g., on a website of the platform) in step 320. Once the feedback has been published or otherwise captured, the reviewer may be directed to a homepage of the platform in step 332. For example, the homepage may be part of a website providing accessing to a directory of professionals (e.g., doctors, lawyers, accountants, etc.), a website dedicated to reviews of products, services, and/or professionals, an ecommerce website, etc.

Returning to step 312, the negative-feedback-handling sub-process may comprise a verification process in step 328, which may be similar to the verification process described with respect to steps 310, 322, and 334. Specifically, the verification process may comprise receiving an email address of the reviewer in step 328. In step 340, an email message is sent to the email address of the reviewer. The email message may comprise a link (e.g., comprising a URL) and/or code (e.g., character string) to confirm that the email address is valid and accessible by the reviewer. In step 344, if the reviewer follows the link and/or enters the code into a confirmation user interface of the platform, the email address is confirmed to be valid and accessible to the reviewer. In embodiments which utilize paid and free accounts, either from step 328 or from step 344, for a paid account, the reviewer may be sent a “thank you” email in step 336 or 352, respectively, and, for an account that is not paid, the reviewer may be directed to a homepage of the platform in steps 338 and 354, respectively.

In an alternative embodiment with paid and free accounts, if, in step 312, the reviewed entity has a paid account, process 300 proceeds to step 324 in which the feedback is sent to the reviewed entity (e.g., prior to or in lieu of publication) and may be sent to the reviewed entity, sales department of the entity and/or operator, and/or other recipient. On the other hand, if the reviewed entity does not have a paid account, process 300 proceeds to step 326 in which the feedback may be sent to the reviewed entity, sales department of the entity and/or operator, and/or other recipient.

Returning to step 342, after a reviewer publishes the positive feedback, the reviewer may be directed to a homepage of a website hosted by the platform in step 346. In an alternative embodiment, with paid and free accounts, if the reviewed entity has a paid account, process 300 proceeds to step 348 in which the positive feedback is sent to the reviewed entity and may be sent to the sales department or the entity or operator. On the other hand, if the reviewed entity does not have a paid account, process 300 proceeds to step 350 in which the positive feedback is sent to the reviewed entity, sales department of the entity or operator, and/or other recipient.

In an embodiment, feedback may be received from a reviewer directly on a website of the reviewed entity. In this case, the feedback-submission module may be integral to the reviewed entity's website or may be executed on a separate platform and interfaced with the reviewed entity's website. The feedback-submission module or a separate software module may also allow the reviewed entity (in addition or alternatively to the reviewer) to specify one or more external platforms (e.g., from a plurality of external platforms, such as review sites, social networking sites, etc.) to which the received feedback should be published. Advantageously, this allows the reviewed entity to decide the external platform(s) on which feedback should be posted based on its own factors, such as which external platform(s) have lower-than-desired feedback for the entity.

In an embodiment, any of the above-described automated decisions, including any submitted feedback (whether positive or negative), can be manually overridden. For instance, often times, users may be confused and provide a negative rating believing that they are providing a positive rating. Absent the confusion, such users may have provided a high rating (e.g., five stars). In addition, in embodiments which provide users with a user interface comprising inputs for two or more types of feedback (e.g., both a numeric rating and a text-based review), the feedback of one type may not match the feedback of another type (e.g., a positive numeric rating combined with a negative text-based review, or vice versa). Accordingly, user interfaces and inputs may be provided to the submitting user and/or an operator of the platform for manually modifying feedback once it has been submitted and/or for manually directing or supplanting the feedback-submission module's determination of whether a user who has submitted feedback should be directed to the negative-capture user interface or positive-capture user interface. For example, if a user provides inconsistent feedback (e.g., a positive numeric rating combined with a negative text-based review, or vice versa), the user may be directed to a user interface in which the inconsistent feedback is flagged, and prompted to correct the feedback, if necessary.

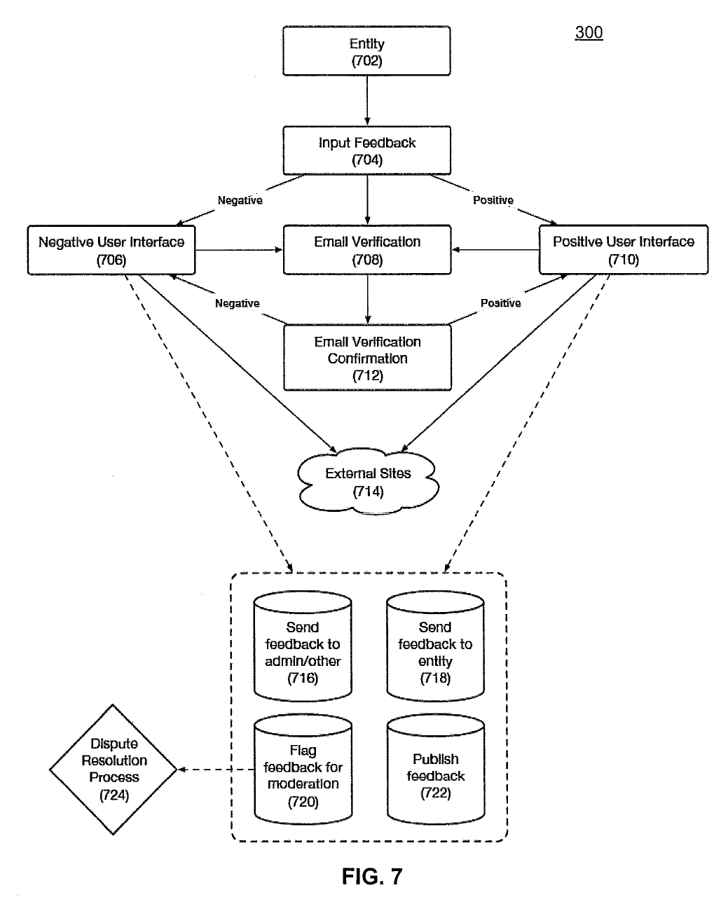

FIG. 7 is a flow diagram for an alternative online feedback submission process 300 of the feedback-submission module, according to an embodiment. In step 702, an entity is identified. For example, a user may select or specify an entity via a user interface provided by platform 110 or via an external platform (e.g., a website at which users review entities, the entity's website, a social networking site, such as an account of the entity on Facebook®, Google+®, etc.) that is communicatively connected to platform 110. It should be understood that a user may identify an entity in any number of ways, including by selecting the entity from a webpage dedicated to the entity, from a list of entities (e.g., generated as the result of a search, such as keyword search, performed by the user), and the like.

In step 704, feedback is input for the entity identified in step 702. For example, once a user has identified an entity, platform 110 or an external platform may generate a user interface comprising inputs through which the user may input feedback (e.g., numerical ratings, binary ratings, textual reviews, etc.). Once the user has completed inputting the feedback, he or she may submit the feedback (e.g., via a POST), at which point, the feedback may be provided as an input to a module, such as the feedback-submission module, which determines whether the feedback is negative or positive, as described elsewhere herein. Prior to submission of the feedback, the user may be required to perform email verification in step 708, in order to validate the feedback. Alternatively, the user may be required to perform email verification in step 708 following submission of the feedback, but prior to the feedback being published or otherwise processed. It should be understood that step 708 is an optional step that can help prevent trolling, fake feedback, etc. Step 708 may be omitted altogether, or may be omitted if the user has already performed email verification in the past, which may be known, for example, if the user has authenticated with the platform (e.g., the user has logged in using an email address or username and password) prior to inputting the feedback in step 704.

If the feedback is negative, process 300 proceeds to step 706. In step 706, a user interface related to negative feedback is provided, as discussed elsewhere herein. On the other hand, if the feedback is positive, process 300 proceeds to step 710. In step 710, a user interface related to positive feedback is provided, as discussed elsewhere herein. From either or both of steps 706 and 710, process 300 may proceed to step 708 in which the reviewing user's email is verified, if not already, as discussed elsewhere herein (e.g., with respect to steps 310 and 328 in FIG. 3).

In embodiments in which feedback may be determined to be neutral, process 300 may end at step 704, may proceed from step 704 to step 708 (e.g., if the user's email address has not already been verified), or may proceed from step 704 to a step in which a user interface related to neutral feedback is provided (e.g., in a similar manner as steps 706 and 710).

As discussed above, in step 708, a reviewing user's email is verified, if not already, as described elsewhere herein. Once the user's email is verified, the user may be sent a confirmation email or directed to a confirmation screen in step 712. The confirmation email or confirmation screen may comprise a link or otherwise direct (e.g., via a redirection) a user to the negative or positive user interface in steps 706 and 710, respectively. Specifically, if the user submitted negative feedback in step 704, the user would be directed to the negative user interface in step 706. On the other hand, if the user submitted positive feedback in step 704, the user would be directed to the positive user interface in step 710.

In steps 706 and 710, the negative user interface and positive user interface, respectively, may comprise one or more inputs or links which enable the reviewing user to submit the feedback input in step 704 to one or more external sites. Thus, in step 714, the reviewing user may submit the input feedback to the one or more external sites, as described in more detail elsewhere herein.

In an embodiment, one or more processes 716, 718, 720, and 722 can be performed after a reviewing user has proceeded through steps 704 and/or 706 or steps 704 and/or 710. It should be understood that one or more of these processes may be performed, in the background, after step 704, after or during step 706, and/or after or during step 710. Alternatively, one or more of the processes may be performed based on one or more interactions with the reviewing user (e.g., via the negative interface, positive interface, and/or other interface).

In an embodiment, process 716 comprises sending or notifying the feedback to an administrator or other recipient. Similarly, process 718 may comprise sending or notifying the feedback to the entity being reviewed. For example, negative and/or positive feedback may be notified to an operator, administrator, or other recipient associated with platform 110, according to process 716, and/or to an administrator or other recipient at the entity being reviewed, according to process 718. It should be understood that the recipient(s) of the feedback may differ depending on whether the feedback is positive or negative. For example, positive feedback may be notified to the entity being reviewed, but not the operator of the platform, whereas negative feedback may be notified to the entity being reviewed and the operator of the platform (e.g., for moderation, billing, etc.).

In an embodiment, process 720 comprises flagging feedback for moderation. In a preferred embodiment, only negative feedback is flagged for moderation. However, it should be understood that an embodiment could also flag positive feedback for moderation (e.g., for offensive language). The flagging of negative feedback can initiate a dispute resolution process 724, which may allow the reviewing user and entity being reviewed to interact directly (e.g., via user interfaces and/or communication methods such as messaging, real-time chat, email, Voice over Internet Protocol (VoIP), telephone, etc.) and/or indirectly (e.g., via a mediator). Dispute resolution process 724 allows the reviewing user to more effectively convey his or her issues to the entity and/or allows the entity to attempt to rectify the reviewing user's issues. Dispute resolution process 724 may also comprise the issuance of a binding or non-binding resolution (e.g., by a selected or provided mediator), similar or identical to professional mediation and/or arbitration.

In an embodiment, process 722 comprises publishing the feedback. In an embodiment, positive feedback is published immediately and/or without intervention, whereas negative feedback is published only after attempts to resolve the negative feedback are unsuccessful. Alternatively, negative feedback may also be published immediately and/or without intervention, while resolution is attempted in the background, and may be retracted or updated with positive or neutralizing feedback after a resolution is achieved. As another alternative, negative feedback may never be published, regardless of whether or not a resolution is achieved. As yet another alternative, negative feedback may never be published if no resolution is achieved and/or if the reviewing user declines to participate in dispute resolution process 724, but otherwise be published (unless the reviewing user retracts the negative feedback during dispute resolution process 724).

2.2. Aggregate Rating Process

In an embodiment, an aggregate feedback process comprises generating an aggregate feedback (e.g., rating and/or group of reviews) for an entity comprising a group of sub-entities for which feedback (e.g., ratings and/or reviews) has been received. This process may be implemented in software as an aggregate-rating module comprising one or more software modules. This aggregate-rating module may be integrated into any website or other online application, regardless of whether that application is a dedicated feedback site, an ecommerce site with a feedback option, an online directory or search engine with a feedback option, or any other application in which it makes sense for users (e.g., consumers) to provide feedback.

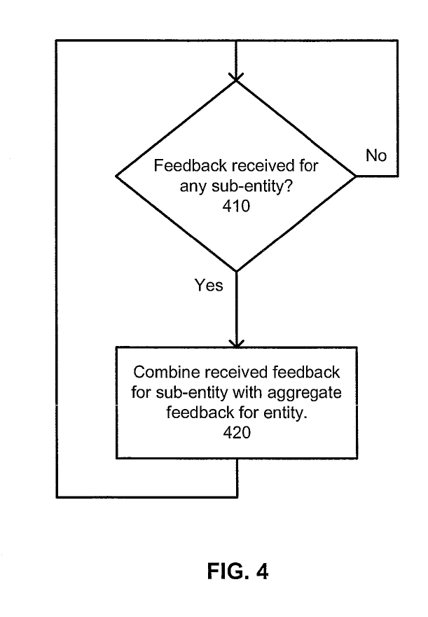

FIG. 4 is a flow chart illustrating an aggregate feedback process 400, according to an embodiment. In step 410, feedback may be received for any of a plurality of sub-entities (e.g., physicians, lawyers, accountants, other professional, office or franchise locations, etc.) of an entity (e.g., medical practice, law firm, accounting firm, other practice, firm, or business, etc.). If feedback is received, process 400 proceeds to step 420. If no feedback is received, process 400 may block until feedback for a sub-entity is received. As used herein, the term “entity” may refer to a person, place, or thing, may refer to an overarching entity have one or more sub-entities, may refer to a sub-entity within an overarching entity, may refer to a group or hierarchy of a plurality of entities. In addition, an “entity,” as discussed herein, may be arbitrary, non-arbitrary, user-defined, system-defined, and/or predefined.

The feedback may comprise a review and/or a rating. For example, a potential reviewer may access a user interface comprising one or more inputs for receiving the feedback. In one embodiment, the user interface may prompt a potential reviewer to specify a numeric rating of a sub-entity, such as a numeric value on a scale from one to five or one to ten, using an input. As an example, the input for the numeric rating may be presented to the potential reviewer as a selection of one to five stars (e.g., directly translating to a rating of one to five).

Whenever new feedback is received for any of the sub-entities associated with an entity, in step 420, process 400 combines the received feedback for the sub-entity with an aggregate feedback for the overarching entity, and returns to step 410. It should be understood that this combination in step 420 may be performed automatically or may be manual or with some further process (e.g., the online feedback submission process discussed above) interposed between steps 410 and 420. In embodiments in which the feedback comprises a numeric rating, the aggregate feedback may also comprise a numeric rating. This aggregate rating may comprise an average (e.g., a straight or weighted average) of all the received ratings for the various sub-entities. In an embodiment, the rating(s) for an entity may be weighted differently, depending on the reviewing user and/or the reviewed entity. It should be understood that the received ratings and aggregate ratings may each comprise a single numeric rating or a plurality of numeric ratings (e.g., for different aspects of a reviewer's experience with the reviewed sub-entity). Alternatively or additionally, in embodiments in which the received feedback comprises a review (e.g., a text-based review), the aggregate feedback may comprise a group of the reviews or snippets from the reviews.

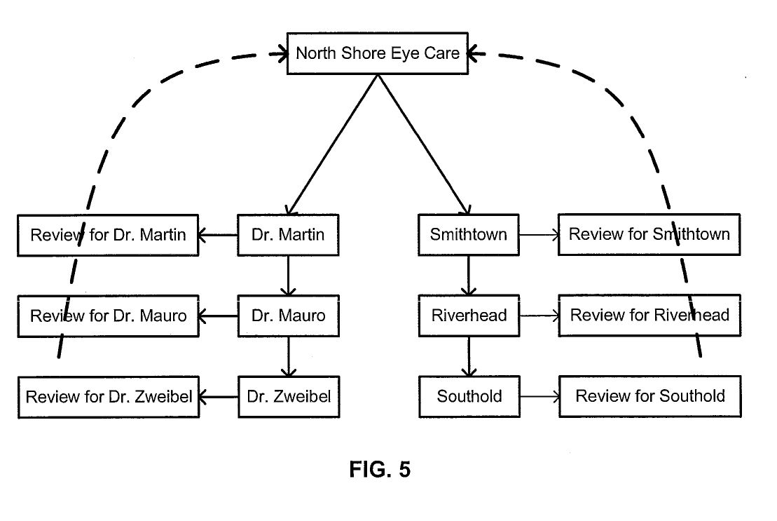

FIG. 5 is a diagram illustrating an example aggregate feedback process for a specific entity (i.e., the “North Shore Eye Care” practice group), according to an embodiment. The entity comprises a plurality of physicians (“Dr. Martin,” “Dr. Mauro,” and “Dr. Zweibel”) and a plurality of locations (“Smithtown,” “Riverhead,” and “Southold”). A reviewer may access a website (e.g., hosted on platform 110) comprising an online directory of practice groups and physicians.

The reviewer may browse or search the directory for one of the physicians or locations. For example, the reviewer may search for Dr. Martin, access a user interface comprising an input for providing feedback (e.g., a review and/or rating) for Dr. Martin, and input feedback for Dr. Martin. The same reviewer or different reviewers may do the same for Dr. Mauro and Dr. Zweibel. Similarly, the same reviewer or different reviewers may browse perform a search for the North Shore Eye Care location in Smithtown, access a user interface comprising an input for providing feedback for the Smithtown location, and input feedback for the Smithtown location. The same reviewer or different reviewers may do the same for the Riverhead location and the Southold location.

All of the feedback for Dr. Martin, Dr. Mauro, Dr. Zweibel, the Smithtown location, the Riverhead location, and the Southold location may then be combined into aggregate feedback for the North Shore Eye Care practice group. The feedback may be combined using any appropriate algorithm, including a straight or weighted average. For example, if each feedback comprises a numeric rating from one to five, and Dr. Martin's feedback was a four, Dr. Mauro's feedback was a three, Dr. Zweibel's feedback was a one, the Smithtown location's feedback was a four, the Riverhead location's feedback was a four, and the Southold location's feedback was a two, an aggregate rating that is a straight average would be three. Alternatively, if the aggregate rating is a weighted average in which physician ratings account for 75% of the rating and location ratings account for 25of the rating, the aggregate rating would be 2.83. It should be understood that aggregation may occur for larger and deeper hierarchies of entities in a similar manner (e.g., an entity with one or more sub-entities, which each have any number of their own sub-entities, and so on).

The aggregate feedback for the North Shore Eye Care practice group may then be displayed to potential consumers. For example, the aggregate feedback may be displayed in association with an entry for the North Shore Eye Care practice group in the online directory of the website and/or a review website. Alternatively or additionally, the aggregate feedback may be displayed directly on a website for the North Shore Eye Care practice group.

Advantageously, the aggregate feedback process described above may provide a commercial advantage for entities, such as medical practices, law firms, accounting firms, and the like. For example, if a sub-entity has lower feedback (e.g., lower rating and/or worse reviews) than the overarching entity, the sub-entity can be enriched by the higher feedback for the overarching entity. Conversely, if the overarching entity would normally have lower feedback than its constituent sub-entities, the overarching entity's feedback will be improved by the higher feedback of its underlying sub-entities. In addition, all entities can be enriched by the increased speed with which feedback can be collected.

Furthermore, the aggregate feedback process allows for the creation of entity groups of previously-ungrouped sub-entities by reviewable entities, an operator of the platform, and/or other users. These entity groups may be referred to herein more simply as entities, as they can be thought of as root entities at the top of a hierarchy of any number of other entities and any number of levels of other entities. In other words, while the examples above have primarily focused on entities naturally comprised of a number of sub-entities, in alternative or additional embodiments, new, arbitrary entities may be constructed, and aggregate feedback (e.g., ratings and/or reviews) may be generated for these arbitrary entities. In other words, a new overarching entity may be created for all sub-entities (e.g., professionals, locations of a particular business or type of business, etc.) meeting one or more criteria, such as sub-entities in a particular geographic region (e.g., Zip code, city, county, state, etc.), in a particular practice (e.g., eye care, dermatology, tax law, etc.) or type of business (e.g., food service, automobile mechanic, etc.), and/or that meet one or more other shared criteria. The aggregate feedback for the new overarching entity can then be compared to the aggregate feedback for another new or preexisting overarching entity to provide the differences in feedback between two groups of sub-entities meeting different sets of one or more criteria. As one example, an aggregate rating and/or grouping of reviews may be generated for all intellectual property attorneys in San Diego, Calif. Another aggregate rating and/or grouping of reviews may be generated for all intellectual property attorneys in San Francisco, Calif. The aggregate ratings and/or groupings of reviews for the intellectual property attorneys in San Diego may then be compared to the aggregate ratings and/or groupings of reviews for the intellectual property attorneys in San Francisco, for example, for the purposes of providing insight into the differences in customer satisfaction between the two sets of attorneys.

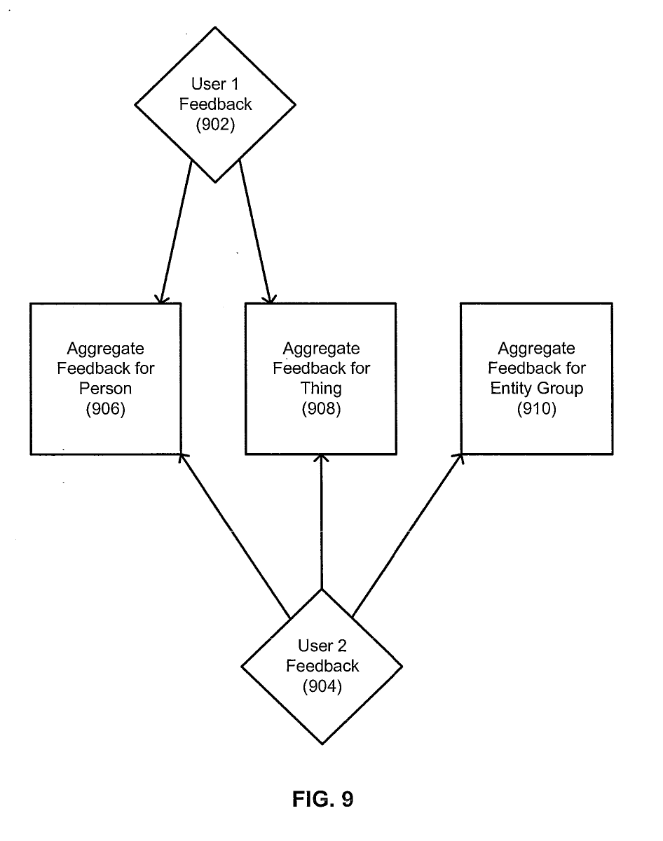

FIG. 9 illustrates an example of how feedback from user(s) may be associated with multiple entities, according to an embodiment. In this example, User 1 has submitted feedback 902. Feedback 902 may be directed towards a thing (e.g., healthcare group, procedure, office location, etc.). For example, User 1 may submit feedback 902 concerning a rhinoplasty procedure which User 1 has undergone. Feedback 902 may comprise sufficient information to identify a particular professional or other person related to the rhinoplasty procedure. For instance, feedback 902 may comprise the name of the doctor who performed the rhinoplasty procedure. Thus, the aggregate feedback process may parse feedback 902, received from User 1, to identify a thing (e.g., rhinoplasty procedure) and a person (e.g., Dr. Martin). The aggregate feedback process may implicitly or explicitly associate the two identified entities (e.g., attribute the rhinoplasty procedure to Dr. Martin). The aggregate feedback process may then incorporate feedback 902 into the aggregate feedback 908 for the identified thing, as well as the aggregate feedback 906 for the identified person. In other words, a single item of feedback from a single user may be used to generate and/or update aggregate feedback for multiple entities (e.g., persons, places, and/or things) that are associated with each other within received user feedback.

As a further example, User 2 has submitted feedback 904. For illustrative purposes, feedback 904 may comprise feedback about the results of a rhinoplasty procedure performed on User 2. Feedback 904 may also mention Dr. Martin. Thus, as with feedback 902 from User 1, the aggregate feedback process may parse feedback 904 to identify the rhinoplasty procedure and Dr. Martin. In addition, Dr. Martin may be associated with an entity group designated as “San Diego Plastic Surgeons” (e.g., in database(s) 112 of platform 110 or by location information identified during parsing of feedback 904). The “San Diego Plastic Surgeons” entity group may be a predefined (e.g., system-defined) entity group or a custom (e.g., user-defined) entity group, as discussed elsewhere herein. The entity group may be constructed dynamically and its aggregate feedback generated dynamically, for example, in response to one or more user queries. In any case, the aggregate feedback process may incorporate feedback 904 from User 2 into each of the aggregate feedback 906 for Dr. Martin, the aggregate feedback 908 for the rhinoplasty procedure, and aggregated feedback 910 for the entity group designated as “San Diego Plastic Surgeons.” In other words, a single item of feedback from a single user may be used to generate and/or update aggregate feedback for multiple entities (e.g., persons, places, and/or things) that are associated with each other within received user feedback and/or within platform 110 (e.g., in database(s) 112 of platform 110).

It should be understood that the above examples are non-limiting illustrations. The aggregate feedback process may identify any number of different entities (e.g., person, place, and/or thing) related to feedback received from a user (e.g., one, two, three, four, etc.), and incorporate elements of the received feedback into the aggregate feedback for each of the identified entities. As mentioned above, the entities related to the feedback received from a user may be identified by parsing the feedback. Parsing the feedback may include, without limitation, identifying proper names or other personal or professional identifiers, identifying locations, identifying procedure names or other procedure identifiers, and the like, that are included in the feedback. Each identified element may identify an entity or entities, or be used as the basis for determining one or more entities. For instance, a person's name in the feedback may be used to identify that person as an entity (e.g., Dr. Martin), a location (e.g., city name, county name, state name, Zip code, etc.) in the feedback may be used to identify an office location to which the feedback pertains (e.g., Smithtown) or an entity group (e.g., “San Diego Plastic Surgeons”), the name of a procedure or a procedure code in the feedback may be used to determine a type of procedure (e.g., rhinoplasty), etc.

As an example, if the aggregate feedback process identifies the name “Dr. Martin,” while parsing received user feedback, it may perform a lookup (e.g., in database(s) 112) to identify aggregate feedback associated with Dr. Martin, and update the aggregate feedback based on the received user feedback. In an embodiment, if no aggregate feedback exists (e.g., in database(s) 112) for Dr. Martin, the aggregate feedback process may generate new aggregate feedback for Dr. Martin based on the received user feedback. This new aggregate feedback would then be updated whenever additional user feedback, pertaining to Dr. Martin, is received (e.g., from additional users).

As a further example, if the aggregate feedback process identifies the name “Dr. Martin,” while parsing received user feedback, it may perform a lookup for additional information regarding Dr. Martin, such as location information (e.g., city, Zip code, etc.) for Dr. Martin's office, a specialty of Dr. Martin, etc. Based on this information, the aggregate feedback process may determine that Dr. Martin is included in an entity group designated as “San Diego Plastic Surgeons” (e.g., based on a determination that Dr. Martin's office is in San Diego and Dr. Martin's specialty is plastic surgery). Thus, the aggregate feedback process may retrieve and/or update or generate new aggregate feedback for the entity group designated as “San Diego Plastic Surgeons” based on the received user feedback.

2.3. Custom Entity Rating Process

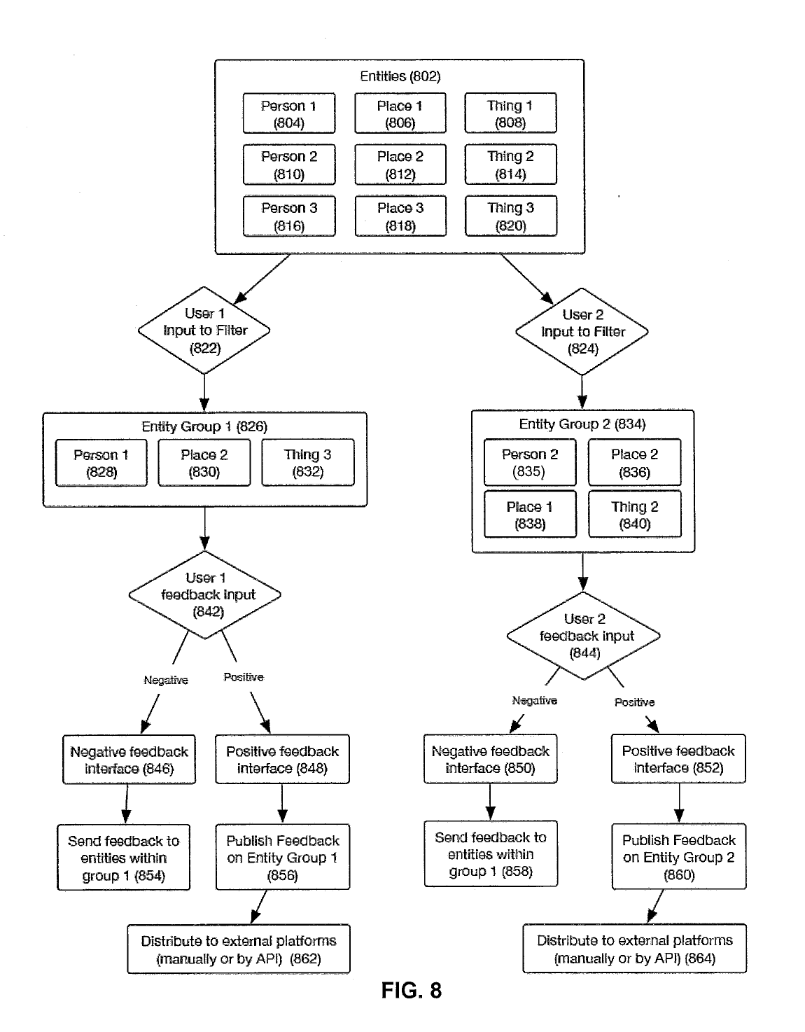

FIG. 8 is a diagram illustrating an example of a custom entity rating process, according to an embodiment. A database or index of entities 802 may be provided (e.g., by platform 110). Database 802 may be accessible to users and/or searchable by users (e.g., by entity name, city, state, Zip code, or other location indicator(s), etc.). Database 802 may comprise a plurality of entities, including persons (e.g., professionals), places (e.g., a particular office), and/or things (e.g., a particular company or medical group).

For example, in step 822, a first user searches database 802 using a first filter (e.g., implemented as a search query). The results of the filter or search, applied by the first user, is a first entity group 826. Alternatively or additionally, a user interface may be provided which allows the first user to select or identify individual entities to be added to first entity group 826. First entity group 826 comprises a first subset of entities. In this example, first entity group 826 comprises person 828, place 830, and thing 832.

In step 824, a second user searches database 802 using a second filter (e.g., implemented as a search query). The results of the filter or search, applied by the second user, is a second entity group 834. Alternatively or additionally, a user interface may be provided which allows the second user to select or identify individual entities to be added to second entity group 834. Second entity group 834 comprises a second subset of entities. In this example, second entity group 834 comprises person 835, place 836, place 838, and thing 840.

It should be understood that first entity group 822 and second entity group 834 may partially overlap, be identical, or not overlap at all, depending on the first and second filters. In other words, each user can arbitrarily set his or her own filter, such that the filter chosen by one user is independent from a filter chosen by a different user. Alternatively or additionally, a user interface may be provided such that each user can select or otherwise identify individual entities or groups of entities to add to an entity group. In this manner, each user can generate his or her own entity group (also referred to herein as an “entity”), which may comprise one or more entities (also referred to herein as a “sub-entity” or “sub-entities”). It should be understood that the term “entity” as used herein can simply be thought of as a node in a hierarchy comprising any number of levels of entities, and is not necessarily a person, place, or thing, but may also include arbitrary or non-arbitrary and user-specified or system-specified groups of people, places, and/or things. That is, an entity group (e.g., first entity group 822 and second entity group 834) simply be thought of as a root entity, and may comprise any number of entities, which may each, in turn, comprise any number of entities, and so on. For example, the city of San Diego may be a root entity comprising North Shore Eye care, which may, in turn, comprise the entities of Dr. Martin, Dr. Mauro, Dr. Zweibel, Smithtown, Riverhead, and Southold, as shown in FIG. 5. Thus, a user may create an entity that comprises any number of sub-entities and any number of levels of sub-entities by aggregating the entities from database 802 in various and arbitrary ways using filters or searches.

In an embodiment, once a user has created an entity group or root entity (e.g., first entity group 826 or second entity group 834), the user may input feedback for that entity group (e.g., via the feedback submission module, described elsewhere herein). For example, the first user inputs feedback in step 842, and the second user inputs feedback in step 844.

In both cases, if the feedback is negative, the user is provided with a negative feedback interface (e.g., step 846 for the first user, and step 850 for the second user). It should be understood that these interfaces may be the same for both users or may be customized depending on the user, the content of the user's feedback, and/or other data generated during the user's session. In addition, if the feedback is positive, the user is provided with a positive feedback interface (e.g., interface 848 for the first user and interface 852 for the second user). Again, it should be understood that these interfaces may be the same for both users or may be customized depending on the user, the content of the user's feedback, and/or other data generated during the user's session.

If the user inputs negative feedback, the feedback may be sent to all or some of the entities within the user-created entity group. For example, if the first user inputs negative feedback in step 842, the negative feedback may be sent to all or some entities within entity group 826—i.e., person 828, place 830, and/or thing 832—in step 854. Similarly, if the second user inputs negative feedback in step 844, the negative feedback may be sent to all or some entities within entity group 834—i.e., person 835, place 836, place 838, and/or thing 840—in step 858. It should be understood that the negative feedback may not necessarily be sent to all entities within each entity group. For example, if person 828 is someone who works at or for place 830, the negative feedback may be sent to only a single recipient for person 828 and place 830 (e.g., only to person 828, or only to an administrator of place 830), in order to reduce redundancy. Alternatively, the negative feedback may be sent to both person 828 and place 830, depending on design choice and/or user preference.

On the other hand, if the user inputs positive feedback, the feedback may be published for the user-created entity group. For example, if the first user inputs positive feedback in step 842, the positive feedback may be published for the first entity group 826 in step 856. In addition, the positive feedback may be distributed to one or more external platforms (manually or via an API) in step 862, as described elsewhere herein. Similarly, if the second user inputs positive feedback in step 844, the positive feedback may be published for the second entity group 834 in step 860 and distributed to one or more external platforms (manually or via an API) in step 864, as described elsewhere herein.

3. Example Processing Device

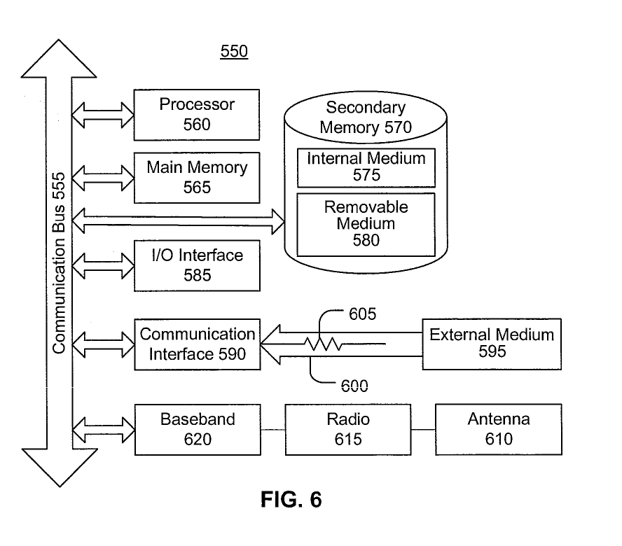

FIG. 6 is a block diagram illustrating an example wired or wireless system 550 that may be used in connection with various embodiments described herein. For example the system 550 may be used as or in conjunction with one or more of the mechanisms, processes, methods, or functions (e.g., to store and/or execute the application or one or more software modules of the application) described above, and may represent components of server(s) 110, user system(s) 130, and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Perl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block-oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software, such as the disclosed application) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the disclosed embodiments as previously described.

In this description, the term “computer-readable medium” is used to refer to any non-transitory computer-readable storage media used to provide computer-executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer-readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615, and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the disclosed embodiments as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit, or step is for ease of description. Specific functions or steps can be moved from one module, block, or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA, or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A system comprising:
at least one hardware processor; and
one or more software modules that, when executed by the at least one hardware processor,
receive first feedback for a first entity from a first user,
receive second feedback for a second entity from a second user,
for each of the first and second feedback, determine whether the feedback is negative or positive, and,
when the feedback is negative, provide a first user interface, to each user, comprising one or more inputs for receiving information about the negative feedback from the user, without publishing the negative feedback, and,
when the feedback is positive, provide a second user interface, to each user, comprising one or more inputs to facilitate publication of the positive feedback on a plurality of external web sites, and
generate aggregate feedback representing feedback for an entity group that comprises both the first entity and the second entity, based, at least in part, on published feedback for the first entity and published feedback for the second entity.

2. The system of claim 1, wherein the one or more software modules further:
receive one or more criteria from a user; and
define the entity group to include at least the first entity and the second entity based on the received one or more criteria.

3. The system of claim 2, wherein one or both of the first entity and the second entity represent a person or organization within a geographical region, and wherein the entity group represents the geographical region.

4. The system of claim 2, wherein one or both of the first entity and the second entity represent a person or organization within a single profession, and wherein the entity group represents the single profession.

5. The system of claim 1, wherein the entity group is predetermined based on a relationship between the first entity and the second entity.

6. The system of claim 5, wherein one or both of the first entity and the second entity represent a person within a single organization or a location of the single organization, and wherein the entity group represents the single organization.

7. The system of claim 6, wherein the one or more software modules, for each of the first and second feedback, when the feedback is negative, communicate the feedback to the entity group.

8. The system of claim 1, wherein the one or more software modules, for each of the first feedback for the first entity and the second feedback for the second entity, when the feedback is negative, communicate the feedback to the respective entity.

9. The system of claim 1, wherein facilitating publication of the positive feedback on a plurality of external websites comprises directing the respective user to one or more of the plurality of external websites.

10. The system of claim 1, wherein facilitating publication of the positive feedback on a plurality of external websites comprises automatically publishing the positive feedback to one or more of the plurality of external websites.

11. The system of claim 1, wherein the one or more software modules further generate a user interface, comprising the generated aggregate feedback, for at least one user.

12. The system of claim 1, wherein one or both of the first entity and the second entity represent an association of a plurality of other entities.

13. The system of claim 1, wherein generating aggregate feedback comprises:
weighting the first feedback for the first entity;
weighting the second feedback for the second entity; and
calculating the aggregate feedback based on the weighted feedback for the first entity and the weighted feedback for the second entity.

14. The system of claim 13, wherein the weighting of the first feedback and the second feedback is based, at least in part, on the respective user from whom the feedback was received.

15. The system of claim 13, wherein the weighting of the first feedback and the second feedback is based, at least in part, on the respective entity for which the feedback was received.

16. The system of claim 1, wherein the one or more software modules further, when the feedback is negative, initiate a dispute resolution process between the user, from which the feedback was received, and the entity, for which the feedback was received.

17. A method comprising using at least one hardware processor to:
receive first feedback for a first entity from a first user;
receive second feedback for a second entity from a second user;
for each of the first and second feedback, determine whether the feedback is negative or positive, and,
when the feedback is negative, provide a first user interface, to each user, comprising one or more inputs for receiving information about the negative feedback from the user, without publishing the negative feedback, and,
when the feedback is positive, provide a second user interface, to each user, comprising one or more inputs to facilitate publication of the positive feedback on a plurality of external websites; and
generate aggregate feedback representing feedback for an entity group that comprises both the first entity and the second entity, based, at least in part, on published feedback for the first entity and published feedback for the second entity.

18.-32. (canceled)

33. A non-transitory computer-readable medium having instructions stored therein, wherein the instructions, when executed by a processor, cause the processor to:
receive first feedback for a first entity from a first user;
receive second feedback for a second entity from a second user;
for each of the first and second feedback, determine whether the feedback is negative or positive, and,
when the feedback is negative, provide a first user interface, to each user, comprising one or more inputs for receiving information about the negative feedback from the user, without publishing the negative feedback, and,
when the feedback is positive, provide a second user interface, to each user, comprising one or more inputs to facilitate publication of the positive feedback on a plurality of external websites; and
generate aggregate feedback representing feedback for an entity group that comprises both the first entity and the second entity, based, at least in part, on published feedback for the first entity and published feedback for the second entity.

34.-48. (canceled)
